(19) United States
(12) Patent Application Publication
(10) Pub. No.: US 2026/0169147 A1
(43) Pub. Date: Jun. 18, 2026

(54) METHOD TO ANALYZE AT LEAST ONE OBJECT IN AN ENVIRONMENT OF A SENSOR DEVICE FOR A VEHICLE

(71) Applicant: Valeo Schalter und Sensoren GmbH, Bietigheim-Bissingen (DE)

(72) Inventors: Sambit Mohapatra, Bietigheim-Bissingen (DE); Kevin Krupinski, Bietigheim-Bissingen (DE); Heinrich Gotzig, Bietigheim-Bissingen (DE)

(73) Assignee: Valeo Schalter und Sensoren GmbH, Bietigheim-Bissingen (DE)

(21) Appl. No.: 19/125,031

(22) PCT Filed: Oct. 23, 2023
(86) PCT No.: PCT/EP2023/079427

§ 371 Date: Apr. 28, 2025

(30) Foreign Application Priority Data
Oct. 27, 2022 (DE) 10 2022 128 486.7

(51) Int. Cl. G01S 13/42; G01S 7/41; G01S 13/89; G01S 13/931

(52) U.S. Cl. CPC G01S 13/42; G01S 7/417; G01S 13/89; G01S 13/931

(57) ABSTRACT

A method to analyze at least one object in an environment of a sensor device for a vehicle. The method includes providing a sensor information describing the at least one object by at least one measurement point located at a first radial distance to the sensor device; determining an artificial sensor information describing at least one artificial point in the environment. The artificial point is located at a second radial distance to the sensor device that is greater than the first radial distance by a predetermined distance value. The method includes analyzing the at least one object by applying an analysis algorithm on both the provided sensor information and the determined artificial sensor information.

The invention relates to a method to analyze at least one object in an environment of a sensor device for a vehicle. The invention furthermore relates to a vehicle, a computing device for a vehicle and a computer program product to perform such a method.

A vehicle may comprise at least one sensor device to capture a sensor information describing an environment of the vehicle. The sensor device may be a radar device, a lidar device and/or a camera mounted in the vehicle. At least in case of the radar device and/or the lidar device as the sensor device, the captured sensor information may be a point cloud of multiple measurement points captured by the respective sensor device. However, if an object in the environment is distant from the sensor device, for example 50 meters or more, a local density of measurement points captured by the respective sensor device may be low compared to the local density of measurement points for an object closer to the sensor device. Therefore, the sensor device acquires sparse sensor information for the distant object. This can be disadvantageous for an analysis of the sensor information, especially if the analysis is provided for object detection and/or semantic segmentation.

It is an object of the invention to improve a measurement point density of measurement points provided by a sensor device.

The subject-matter of the independent claims solve this object.

A first aspect of the invention relates to a method to analyze at least one object in an environment of a sensor device for a vehicle. Preferably, the sensor device is mounted in the vehicle. The vehicle may comprise multiple sensor devices which are each configured to capture a sensor information describing the environment of the respective sensor device. The environment is typically defined by a coverage area of the sensor device.

The method comprises providing a sensor information. The sensor information describes the at least one object by at least one measurement point located at a first radial distance to the sensor device. The at least one object described by the sensor information is the object in the environment of the sensor device. The at least one measurement point is, for example, described by a coordinate of the point. In particular, the coordinate is given with respect to the sensor device. The coordinate comprises at least a value that describes the radial distance of the measurement point to the sensor device and/or a reference point of the sensor device. The radial distance may alternatively be referred to as radius or radial coordinate of the measurement point. Typically, the sensor information describes the at least one object by multiple measurement points which are each located at different first radial distances to the sensor device. If there are multiple objects in the environment of the sensor device, the sensor information may describe multiple objects, wherein each object is described by preferably multiple measurement points. The sensor information may be provided to a computing device of the vehicle and/or to an external computing device, such as a server, a backend and/or a cloud-server. The sensor information may be described by sensor data.

The method comprises determining an artificial sensor information. The artificial sensor information describes at least one artificial point in the environment. The artificial point is located at a second radial distance to the sensor device. The second radial distance is greater than the first radial distance by a predetermined distance value. The artificial sensor information hence describes no real point in the environment but a simulated point. The artificial point has not been captured by the sensor device. The sensor information captured by the sensor device thus does not describe the at least one artificial point. Alternatively or additionally, the artificial sensor information may be referred to as synthetic or simulated sensor information. The predetermined distance value may be, for example, 1 millimeter, 2 millimeters, 3 millimeters, 5 millimeters, 8 millimeters, 1 centimeter, 1.5 centimeter, 2 centimeters, 3 centimeters, or in particular 5 centimeters. The distance value may be any value between the mentioned values.

As the second radial distance is greater than the first radial distance, the artificial point is located behind the measurement point when viewed from a perspective of the sensor device. The artificial point is hence a point that may not be detectable by the sensor device because it is located within the object. Hereby, it is assumed that the measurement point is located on a surface of the object. In this case, the artificial point cannot overlap with any measurement point unless, for example, a ray emitted by the sensor device can at least partially penetrate the surface of the object and is reflected at a part of the object that lies behind the surface of the object and is located at the second radial distance.

The method furthermore comprises analyzing the at least one object by applying an analysis algorithm on both the provided sensor information and the determined artificial sensor information. Analyzing may comprise, for example, a classification of the object in the environment. The analysis algorithm comprises at least one rule and/or condition to analyze the object. The analysis algorithm is not just performed under consideration of measured sensor data, meaning the provided sensor information, but also under consideration of the artificially created data, meaning the determined artificial sensor information. Each measurement point describing the object is at least duplicated due to considering the at least one artificial point, so that a number of points, on which the analysis algorithm is applied, is at least doubled compared to the number of measurement points described by the provided sensor information. If there are multiple artificial points chosen for each measurement point, it is possible to increase the total number of points that are considered for analyzing the object by a predetermined factor, wherein the factor depends on the number of artificial points per measurement point. As a result, a cloud of points describing the object is increased whereas a structure and/or a contour of the object is preserved. The structure and/or contour is preserved due to the location of the at least one artificial point with respect to the respective measurement point in radial direction. A local density of the points used for analyzing the at least one object is hence increased compared to a local density of the measurement points. Therefore, a measurement point density of the measurement points provided by the sensor device is increased.

An embodiment comprises that the provided sensor information and the determined artificial sensor information describe the respective at least one point using spherical coordinates. The at least one measurement point and the at least one artificial point are located at a common polar angle and azimuthal angle. This means that if there is, for example, exactly one measurement point for which exactly one artificial point is determined, these two points have different radial distances because the first radial distance is unequal to the second radial distance. However, they have the same polar angle and the same azimuthal angle. When viewed from the perspective of the sensor device, both points are hence located behind each other in radial distance but not next to each other in directions perpendicular to the radial direction due to the same polar and azimuthal angle.

If there are multiple measurement points and for each of them at least one artificial point is determined, each measurement point and the related or associated at least one artificial point are located at the respective common polar angle and azimuthal angle. This means that if there are multiple measurement points, they may have different polar angles and azimuthal angles. However, the artificial points for each one of the multiple measurement points each coincide in both polar angle and azimuthal angle but differ in radial distance. This means that the sensor information describing the at least one object by the at least one measurement point uses spherical coordinates so that the at least one measurement point is described by the first radial distance, the polar angle and the azimuthal angle. The artificial sensor information describes the at least one artificial point using spherical coordinates as well so that the artificial point is described by the second radial distance, the polar angle and the azimuthal angle. There is hence no first and second polar angle and/or first and second azimuthal angle but only one common angle for the polar angle and the azimuthal angle, respectively. Therefore, the at least one artificial point does not affect, for example, a shape and/or size of the object but only the density of measurement points on the surface of the object. This is achieved by maintaining the polar and azimuthal angle of the respective measurement and artificial point constant.

A further embodiment comprises that the measurement point is part of at least one three-dimensional point cloud captured by the sensor device. The sensor device is hence configured to detect a three-dimensional object. Each measurement point represents one point on a surface of the object so that the three-dimensional cloud of individual measurement points represents the surface of the object. The three-dimensional point cloud is typical raw data provided by the sensor device of the vehicle. The method can thus be based on typical sensor information provided by a vehicle.

According to a further embodiment, the method comprises projecting the provided sensor information and the determined artificial sensor information onto a two-dimensional plane before applying the analysis algorithm. This means that the three-dimensional point cloud is first processed to create a two-dimensional arrangement of the points. The two-dimensional arrangement of the points, meaning the two-dimensional plane of measurement points, may be referred to as two-dimensional point cloud. Instead of analysis a three-dimensional view of the object, the three-dimensional point cloud is transformed to a two-dimensional view of the object, such as a static and/or moved image of the points. It is particularly reasonable to transfer both the sensor information as well as the artificial sensor information from three dimensions to two dimensions in order to apply typical analysis algorithms developed for analyzing two-dimensional sensor information, for example.

Moreover, an embodiment comprises that the projected sensor information and the projected artificial sensor information describe the environment from a bird's-eye view and/or a side view. This is particularly reasonable if the sensor device is a component of the vehicle. Typically, multiple sensor devices are located or mounted in the vehicle so that the entire environment, for example a 360-degree view of the environment of the vehicle, may be described by the sensor information. In such a scenario, a perspective of the measurement points in the two-dimensional plane is often a view of the environment from above. The view from above is the bird's-eye view. It may alternatively referred to as a top-side view. However, if only sensor information from one side of the vehicle is provided, it is possible to choose, for example, a plane defined by a height and length direction of the vehicle as the two-dimensional plane. As a result, the side view is generated. It may be alternatively referred to as a side perspective on the environment. The two-dimensional plane of the side view is preferably arranged perpendicular to the two-dimensional plane of the bird's-eye view. Ultimately, particularly useful views on the environment may be created and used for analyzing the object.

A preferred embodiment comprises that the artificial sensor information describes a first artificial point and at least one second artificial point. Preferably, it describes multiple second artificial points. The second radial distance of the first artificial point is greater than the first radial distance by the predetermined distance value. Furthermore, the second radial distance of the first artificial point is smaller than the second radial distance of the at least one second artificial point by the predetermined distance value. In other words, when viewed in radial direction, the measurement point is placed first, followed by the first artificial point that is then followed by the at least one second artificial point. It is hence possible to position at least two artificial points in radial direction behind the measurement point. All these artificial points preferably have the same polar and azimuthal angle as the measurement point. As a result, the point density at the location of the respective measurement point can be increased significantly. This explains particularly well why the contours of the object are visible with higher contrast if the artificial sensor information is determined and considered.

Another embodiment comprises that the artificial sensor information describes multiple second artificial points. The second radial distances of the multiple second artificial points are located spatially apart from each other in radial direction by the predetermined distance value. A distance between two neighboring second artificial points in radial direction is hence equivalent to the predetermined distance value. All artificial points corresponding to a single one measurement point are thus equidistant to each other in radial direction. Therefore, it is particularly easy to add new artificial points, because they are all located at the predefined distance value to each other.

Another embodiment comprises that the artificial points are distributed over a predetermined radial distance range. The radial distance range extents from the first radial distance as a minimal radial distance to a predetermined maximum radial distance. The radial distance range is, for example, 1 centimeter, 3 centimeters, 5 centimeters, 10 centimeters, 15 centimeters, 20 centimeters, 30 centimeters, 50 centimeters, or in particular 1 meter long. Depending on the predetermined distance value the number of artificial points necessary to fill up the entire predetermined radial distance range may be determined. It is hence possible to set a radial distance range up to which the at least one artificial point can be located in radial direction behind the measurement point. It is hence possible to obtain different point cloud densities by varying the radial distance range and/or the predetermined distance value.

According to a preferred embodiment, determining the artificial sensor information is only done for the measurement point for which the first radial distance is greater than a predetermined minimal value. This means that the method comprises determining the artificial sensor information only for the measurement point that is located so far away from the sensor device that the first radial distance is greater than the predetermined minimal value. The predetermined minimal value may be, for example, 10 meters, 20 meters, 30 meters, 40 meters, 50 meters, 60 meters, 70 meters, 80 meters, 90 meters, or in particular 100 meters. The minimal value may be any value between the listed values. It is hence possible to not determine any artificial sensor information for an object that is located at a closer first radial distance to the sensor device than a distance according to the predetermined minimal value or that is located at the distance according to the predetermined minimal value. However, if the object is located further away than the distance according to the predetermined minimal value, it is assumed that particularly sparse sensor information is provided and in particular captured by the sensor device so that the artificial sensor information is determined. This reduces required calculation time because the artificial sensor information is only determined when sparse sensor information is expected.

Alternatively or additionally, for the measurement point for which the first radial distance is smaller than or equal to the predetermined minimal value, a number of artificial points may be reduced compared to the number of artificial points determined for the measurement point for which the first radial distance is greater than the predetermined minimal value. However, the number of artificial points may be larger than 0.

According to another embodiment, the method comprises capturing the sensor information by a radar device, a lidar device and/or a time-of-flight camera. In general, the sensor information describes a location of at least one point of an object relative to the sensor device. The sensor information is hence preferably an information that describes a distance between the object and the radar device. The captured sensor information is provided as the sensor information for which the artificial sensor information is determined. There are hence versatile sensor devices possible which may provide the sensor information.

The sensor device is preferably mounted in a vehicle, for example, in a bumper and/or chassis of the vehicle. The sensor device may be located at a front area, a rear area and/or a side area of the vehicle.

Another embodiment comprises transforming a captured raw sensor information from Cartesian coordinates to spherical coordinates and providing the transformed sensor information as the sensor information. In case the sensor device captures its data in Cartesian coordinates it is hence necessary to add a transforming step in order to determine for each measurement point the respective coordinates in spherical coordinates. Spherical coordinates define a position in radial direction. The position of the respective measurement point is referred to as the respective first radial distance. It is possible that a back transformation from spherical coordinates to Cartesian coordinates is performed before the analysis algorithm is applied on the sensor information and the artificial sensor information. To transform between Cartesian coordinates and spherical coordinates, typical transformation techniques for coordinate transformation between these two coordinate systems may be applied. The method hence does not require the sensor device to provide the sensor information in spherical coordinates.

Another embodiment comprises that the analysis algorithm performs object detection and/or semantic segmentation. The analysis algorithm may, in particular, comprise a convolutional neural network. The analysis algorithm is at least configured to, for example, detect, identify and/or classify the object. By means of the convolutional neural network, it is, for example, possible to perform a classification of the object if the convolutional neural network is trained to classify objects. Semantic segmentation means that each pixel and hence each measurement point and artificial point is assigned to a specific object class. It is possible that an object information is determined by applying the analysis algorithm on the provided sensor information and the determined artificial sensor information. The object information may describe a result of the analysis algorithm, for example, the object and/or a class of the object. The object information may be provided to a function of the vehicle, for example a driver assistance system. The method may hence provide necessary information for the function of the vehicle.

Another aspect of the invention relates to a vehicle. The vehicle is configured to perform the above-described method. The vehicle corresponds to the first vehicle. The vehicle is a motor vehicle, in particular a passenger car, a truck, a bus and/or motor cycle. The vehicle performs the method. The vehicle preferably comprises the sensor device, for example, the radar device, the lidar device and/or the time-of-flight camera. Preferably, the vehicle comprises a computing device, wherein the computing device determines the artificial sensor information and applies the analysis algorithm on the provided sensor information and the determined artificial sensor information. The sensor device of the vehicle therefore provides the sensor information to the computing device.

A further aspect of the invention relates to a computing device for a vehicle. The computing device is configured to perform the above-described method. The computing device performs the described method, in particular, at least one of the embodiments or a combination of the embodiments of the described method. The computing device comprises a processor device. The processor device may comprise at least one microprocessor and/or at least one microcontroller and/or at least one FPGA (field programmable gate array) and/or at least one DSP (digital signal processor). Further, the processor device may comprise program code. The program code may alternatively be referred to as a computer program product or computer program. The program code may be stored in a data memory of the processor device.

Another aspect of the invention relates to a computer program product. The computer program product is a computer program. The computer program product comprises instructions, which, when the program is executed by a computer, such as the computing device, cause the computer to perform the inventive method.

The embodiments described in connection with the method, individually as well as in combination with each other, apply accordingly, as far as applicable, to the inventive vehicle, computing device and/or computer program product. The invention includes combinations of the described embodiments.

Thereby show:

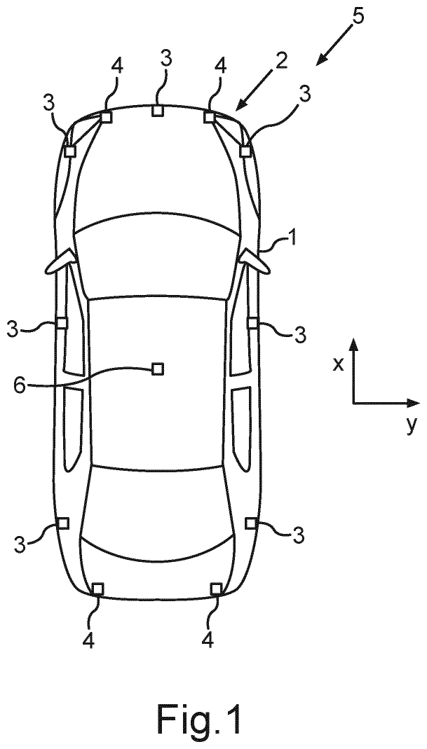

FIG. 1 a schematic representation of a vehicle comprising multiple sensor devices;

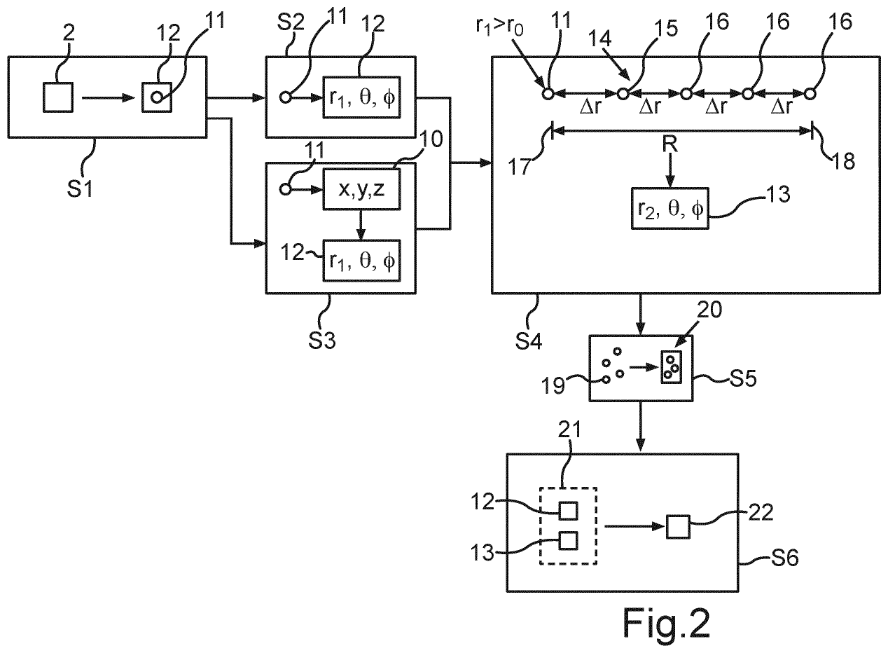

FIG. 2 a schematic representation of a method to analyze at least one object in an environment of a sensor device for a vehicle; and

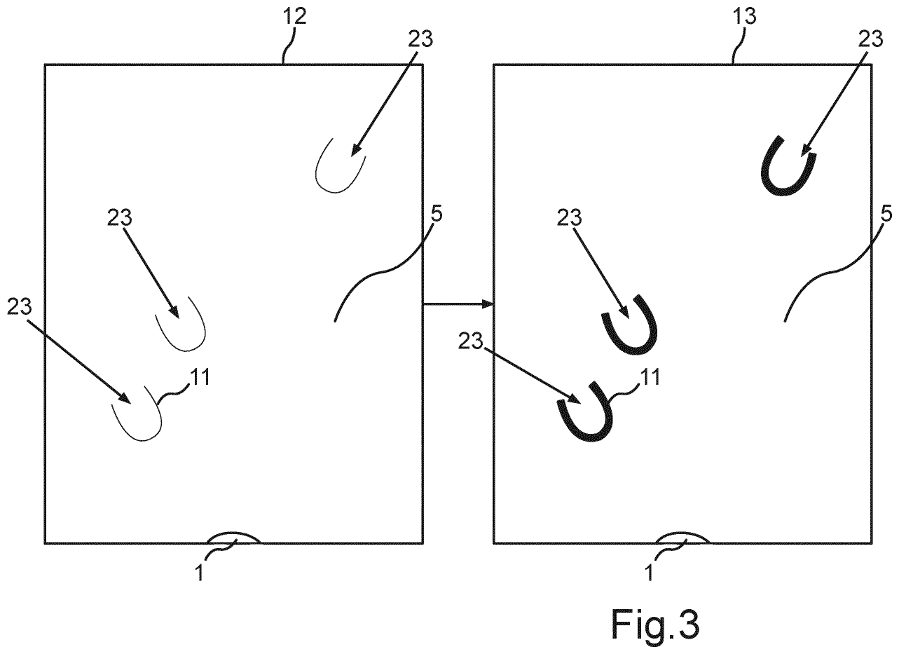

FIG. 3 a schematic representation of a sensor information and an artificial sensor information.

FIG. 1 shows a vehicle 1 that comprises multiple sensor devices 2. Here, it comprises multiple radar devices 3 and lidar devices 4 as sensor devices 2. Alternatively or additionally, the sensor device 2 may be a time-of-flight camera (not sketched here). Here, the radar devices 3 and lidar devices 4 are located in a front area, a rear area as well as in side areas of the vehicle 1. The vehicle 1 may comprise more or less radar devices 3 and/or lidar devices 4. The sketched sensor devices 2 may be located at different positions within the vehicle 1. Preferably, the radar devices 3 and the lidar devices 4 are located, for example, in bumper and/or a chassis of the vehicle 1. The two radar devices located on the opposite sides in y-direction are, for example, located in doors of the vehicle 1. The respective sensor device 2 is configured to capture data describing an environment 5 of the vehicle 1. The environment 5 is preferably defined by a coverage area of the respective sensor devices 2.

The vehicle 1 may comprise a computing device 6. The computing device 6 may alternatively be referred to as a control unit or a control device of the vehicle 1. The computing device 6 is configured to, for example, perform calculations. It may hence perform steps of a method to analyze at least one object 23 (see reference sign 23 in FIG. 3) in the environment 5 of the sensor device 2 and thus of the vehicle 1.

FIG. 2 shows steps of the method to analyze the at least one object 23 in the environment 5 of the sensor device 2. In a step S1, the method may comprise capturing a sensor information 12 by the radar device 3, lidar device 4 and/or the time-of-flight camera of the vehicle 1. The sensor devices 2 capture the sensor information 12. The sensor information 12 describes the at least one object 23 in the environment 5 of the sensor device 2 by at least one measurement point 11.

A step S2 comprises providing the sensor information 12, which describes the at least one object 23 by the at least one measurement point 11. The at least one measurement point 11 is located at a first radial distance r₁. The first radial distance r₁ is a distance relative to the sensor device 2 or another reference point. In general, the measurement point 11 is described by spherical coordinates. The measurement point 11 is therefore described by the first radial distance r₁, a polar angle θ and an azimuthal angle φ. The sensor information 12 may be provided to the computing device 6.

In case the sensor device 2 captures the sensor information 12 in Cartesian coordinates, a raw sensor information 10 is captured by the sensor device 2. The captured raw sensor information 10 is then transformed to spherical coordinates in a step S3. Afterwards, the transformed sensor information is provided as the sensor information 12.

A step S4 comprises determining an artificial sensor information 13, which describes at least one artificial point 14 in the environment 5. The artificial point 14 is located at a second radial distance r₂ with respect to the sensor device 2. The second radial distance r₂ is greater than the first radial distance r₁ by a predetermined distance value Δr. In more detail, the artificial point 14 is described by the same polar angle θ and the same azimuthal angle q as the measured point 11. This means that only the radial distances r₁, r₂ differ when comparing the measurement point 11 to the artificial point 14. In other words, the provided sensor information 12 and the determined artificial sensor information 13 describe the respective at least one point 11, 14 using spherical coordinates, wherein the at least one measurement point 11 and the at least one artificial point 14 are located at a common polar angle θ and a common azimuthal angle q.

The artificial sensor information 13 may describe a first artificial point 15 and at least one second artificial point 16. Here, three second artificial points 16 are sketched. More or less second artificial points 16 are possible. The second radial distance r₂ of the first artificial point 15 is greater than the first radial distance r₁ of the measurement point 11 by the predetermined distance value Δr. The second radial distance r₂ of the first artificial point 15 is smaller than the second radial distance r₂ of the at least one second artificial point 16 by the predetermined distance value Δr. When there are multiple second artificial points 16, the second radial distances r₂ of the multiple second artificial points 16 are respectively located spatially apart from each other in radial direction by the predetermined distance value Δr. In total, the artificial points 14 may be distributed over a predetermined radial distance range R. The radial distance range R extents from the first radial distance r₁ as a minimal radial distance 17 to a predetermined maximum radial distance 18. Here, the radial distance range R is four times the predetermined distance value Δr.

The method may comprise determining the artificial sensor information 13 only for the measurement point 11 for which the first radial distance r₁ is greater than a predetermined minimal value r₀. The minimum value r₀ may be for example 60 meters or 80 meters with respect to a position of the sensor device 2 and/or the vehicle 1.

The measurement point 11 may be part of at least one three-dimensional point cloud 19 that may be captured by the sensor device 2. In a step S5 the provided sensor information 12 and the determined artificial sensor information 13 may be projected onto a two-dimensional plane 20. This means that if the projected sensor information 12 and artificial sensor information 13 form a two-dimensional collection of points 11, 14. The projected sensor information 12 and the projected artificial sensor information 13 may describe the environment 5 from a birds-eye view and/or a side view.

A step S6 comprises analyzing the at least one object 23 by applying an analysis algorithm 21 on both the provided sensor information 12 and the determined artificial sensor information 13. The analysis algorithm 21 may perform object detection and/or semantic segmentation. The analysis algorithm 21 may comprise a convolutional neural network in order to, for example, classify the object 23. The analysis results of applying the analysis algorithm 21 is comprised by an object information 22. The object information 22 may describe the object 23, in particular, a class of the object 23.

FIG. 3 shows an example for the sensor information 12 and a corresponding artificial sensor information 13. In the environment 5 of the vehicle 1 three other vehicles 1 are located. The three other vehicle 1 are the objects 23. More objects 23 and/or other objects 23 in the environment are possible. However, at the contour and hence at the surface of each of the objects 23 only few measurement points 11 are captured by the sensor device 2, as indicated by the respective thin lines in FIG. 3. By adding multiple artificial points 14 for each of the measurement points 11, denser contours of the objects 23 are artificially created, as indicated by the respective comparatively thick lines in FIG. 3. As a result, analyzing results achieved by applying the analysis algorithm 21 to both the sensor information 12 and the artificial sensor information 13 may be increased compared to only applying it to the sensor information 12.

In summary, extrapolating range bearing data for sensor data augmentation in range sensors has been described. The invention is related to sensor data from radar or lidar sensors, meaning from the radar devices 3 and/or lidar devices 4, which create a respective point cloud 19 as measurement results. The sensor data is comprised by the provided sensor information 12. The point clouds 19 are projected to the two-dimensional plane 20.

Due to low density of the point cloud 19 a classificator (analysis algorithm 21) has problems to classify the object 23. The idea is to increase the point cloud density without adding noise regarding the shape of the object 23. This is done by adding per measurement point 11 additional artificial points 14 distributed in the radial direction r₁, r₂. Due to this approach, the contour is maintained and almost no noise is added.

Regarding the transformation to spherical coordinates, each three-dimensional point (x, y, z) in the point cloud 19 produced from the sensor device 2 can be represented in spherical coordinates as (r, θ, φ), where r is range or the radial distance, θ is the elevation (polar angle) and q is the azimuthal angle:

$$r = \sqrt{{x}^{2} + {y}^{2} + {z}^{2}}$$

$$θ = {sin}^{- 1} - \frac{z}{r}$$

$$φ = {tan}^{- 1} \frac{x}{y}$$

Increasing the radial distance r by small quantities of Δr by preserving θ and φ gives new points inside the object 23 as if the ray penetrated the object 23. This can help make the point clouds 19 denser while preserving structure and contour of the object 23 in scene.

The proposed method does not use any learning based convolutional neural networks but rather is a simple application of mathematical methods to extrapolate rays connecting sensor origin and observed points. Therefore, the chances of error are very low compared to the convolutional neural network-based methods. Also training the convolutional neural network needs a notated ground truth data, which is not required in the proposed method. Furthermore, the proposed method can be easily tuned to augment only sections of input point clouds 19 such as only at ranges larger than 80 meters. This means the minimal value r₀ can be considered and set at 80 meters, for example. The method is applicable to all types of range sensors and not limited to lidars.

1. A method to analyze at least one object in an environment of a sensor device for a vehicle, the method comprising:
providing a sensor information describing the at least one object by at least one measurement point located at a first radial distance to the sensor device;
determining an artificial sensor information describing at least one artificial point in the environment,
wherein the artificial point is located at a second radial distance to the sensor device that is greater than the first radial distance by a predetermined distance value; and
analyzing the at least one object by applying an analysis algorithm on both the provided sensor information and the determined artificial sensor information.

2. The method according to claim 1,
wherein the provided sensor information and the determined artificial sensor information describe the respective at least one point using spherical coordinates,
wherein the at least one measurement point and the at least one artificial point are located at a common polar angle and azimuthal angle.

3. The method according to claim 1, wherein the measurement point is part of at least one three-dimensional point cloud captured by the sensor device.

4. The method according to claim 3, further comprising projecting the provided sensor information and the determined artificial sensor information onto a two-dimensional plane before applying the analysis algorithm.

5. The method according to claim 4, wherein the projected sensor information and artificial sensor information describe the environment from a bird's-eye view and/or a side view.

6. The method according to claim 1,
wherein the artificial sensor information describes a first artificial point and at least one second artificial point,
wherein the second radial distance of the first artificial point is greater that the first radial distance by the predetermined distance value but smaller than the second radial distance of the at least one second artificial point by the predetermined distance value.

7. The method according to claim 6,
wherein the artificial sensor information describes multiple second artificial points,
wherein the second radial distances of the multiple second artificial points are respectively located spatially apart from each other in radial direction by the predetermined distance value.

8. The method according to claim 7, wherein the artificial points are distributed over a predetermined radial distance range extending from the first radial distance as a minimal radial distance to a predetermined maximum radial distance.

9. The method according to claim 1, further comprising determining the artificial sensor information only for the measurement point for which the first radial distance is greater than a predetermined minimal value.

10. The method according to claim 1, further comprising capturing the sensor information by a radar device, a lidar device and/or a time-of-flight camera.

11. The method according to claim 10, further comprising transforming a captured raw sensor information from Cartesian coordinates to spherical coordinates and providing the transformed sensor information as the sensor information.

12. The method according to claim 1, wherein the analysis algorithm performs object detection and/or semantic segmentation and comprises a convolutional neural network.

13. A vehicle configured to perform the method according to claim 1.

14. A computing device for a vehicle configured to perform the method according to claim 1.

15. A non-transitory computer readable medium comprising a computer program product comprising instructions, which, when the program is executed by a computer, cause the computer to perform the method according to claim 1.
